(19) United States
(12) Patent Application Publication
(10) Pub. No.: US 2014/0335922 A1
(43) Pub. Date: Nov. 13, 2014

(54) Phone Ring

(71) Applicants: Cilki Shanrae West, Cypress, TX (US); Kayla Chalisse Jackson, Cypress, TX (US); Laura Ashley Baker, Houston, TX (US)

(72) Inventors: Cilki Shanrae West, Cypress, TX (US); Kayla Chalisse Jackson, Cypress, TX (US); Laura Ashley Baker, Houston, TX (US)

(21) Appl. No.: 13/764,473

(22) Filed: May 9, 2013

(51) Int. Cl. H04M 1/02

(52) U.S. Cl. CPC H04M 1/026
USPC 455/575.6

(57) ABSTRACT

Phone Ring is a phone case that has a circular inset that can be attached to a single, double or triple finger ring that has a very small prong soldered to the back of the ring to provides a way to insert the ring to the inset piece on the casing and interlock to two together providing a 360 degree swivel for viewing needs and a “drop-proof” grip on your phone. The ring can be worn with or without the case to provide an on the go fashionable look that is easily fastened to the case giving optimal phone protection.

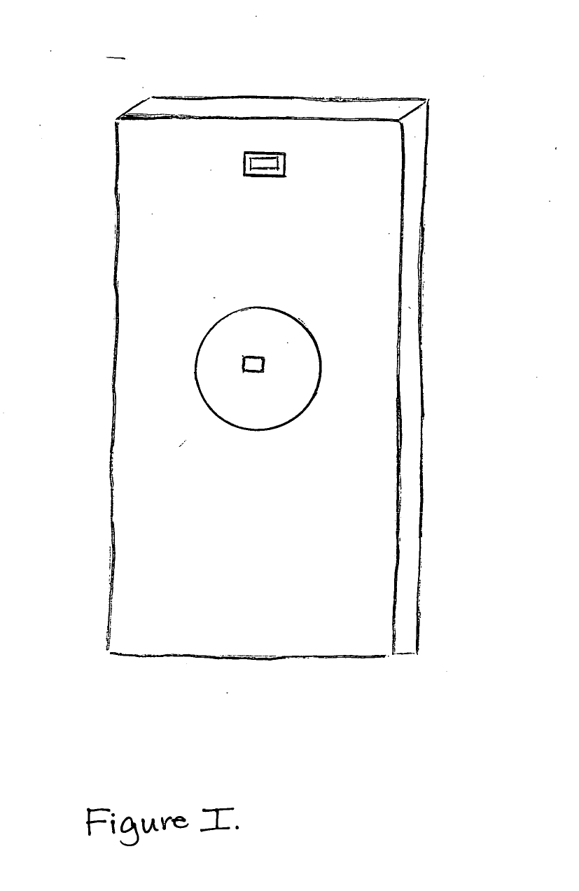

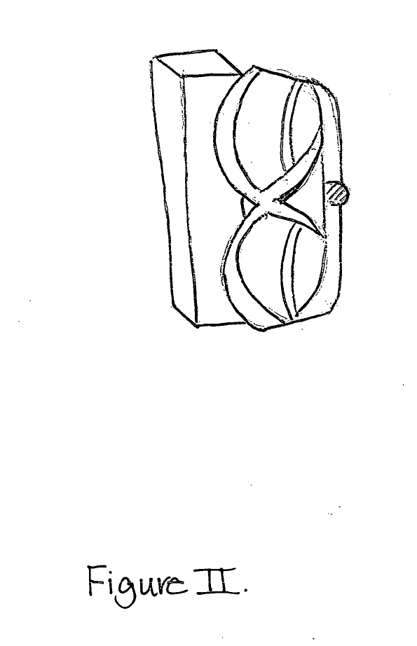

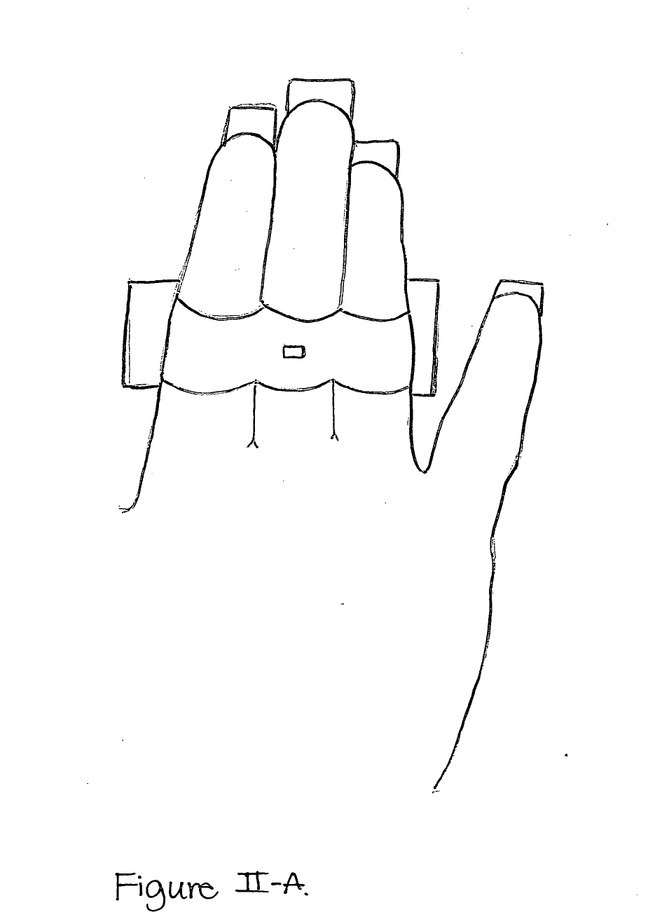

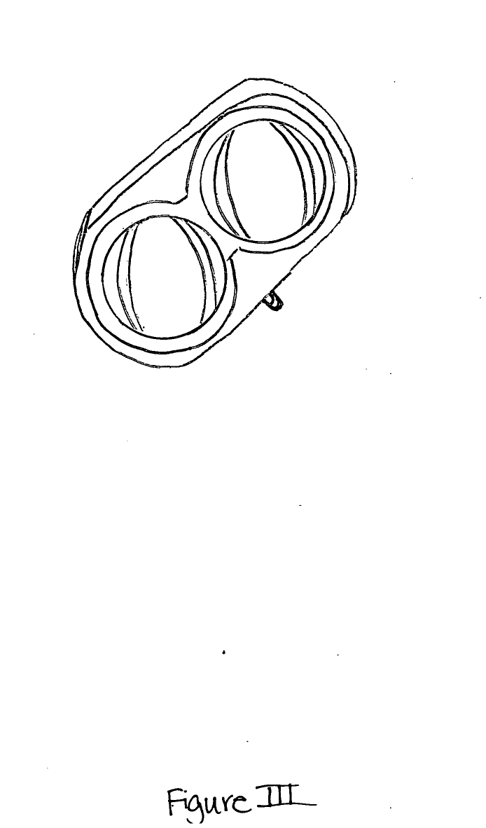

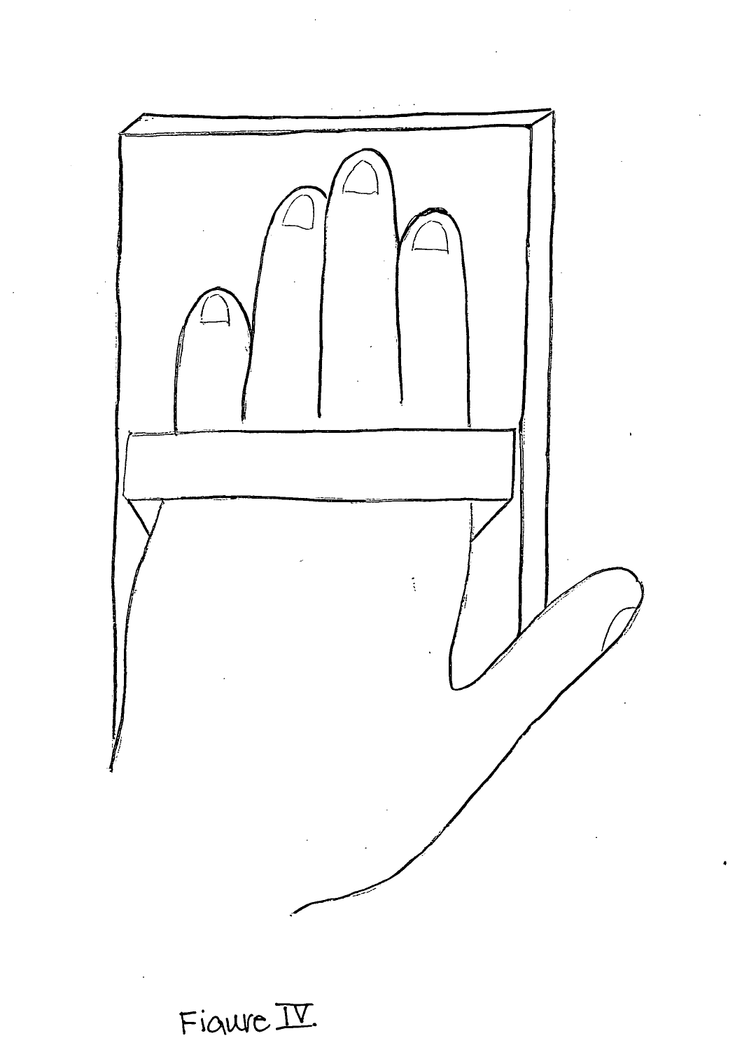

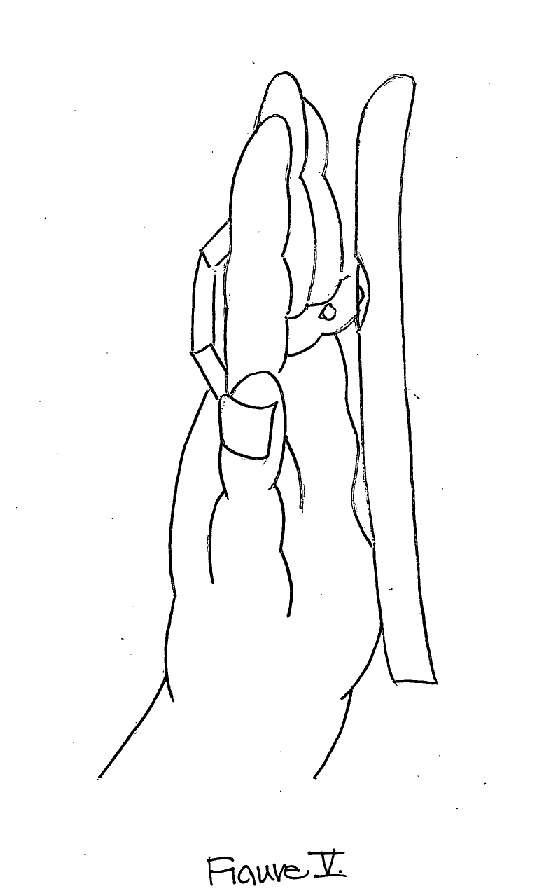

“Don't Loose the grip on your phone . . . let your phone have a grip on you!”

Phone Ring is a new and innovated hand held device that allows you to have your phone connected to your hand, without actually having to grip the phone. It also allows a swivel feature that allows you to turn and lock your phone into horizontal or vertical direction while being capable of swiveling 360 degrees. There are two pieces to this device; Figure I, is the phone case that is put on your phone itself, on the back of the phone case there is a cut out or a fastener or insert with a small whole that has a light magnetic force to interlock with Figure II or Figure III better, which is a ring that has a soldered bar on the back of it, to project a small 3-5 mm screw fixture to be inserted into Figure I and screwed into a locked position vertically or horizontally securing the connection of Figure Ito Figure II or Figure III. Figure III can only be worn on either the index finger alone or the index and the middle finger or the index, middle and ring finger. This is because Figure III has the capabilities to swivel at the point of the 3-5 mm screw, as well as, around the finger; taking the back of the phone from the front of the palm to the back of the hand. This function will allow the consumer to remain on the phone while carrying items or that special loved one. The consumer will be less likely lose the call accidentally, drop holding between shoulder and chin or simply have to hang up. Figure II and III will be either in single, double or triple ring styles with small, medium or large sizes. We will be using either stainless steels, sterling silvers, plastics, leathers or other precious metals. Some rings may incorporate sworaski crystals, patterns and various other cuts and styles to promote fashion further down the line after production of a plane hammered metal ring and plastic covered crystal design. Figure I will be made out of a strong and secure metal that can sustain the weight of the phone and provide of dock for magnetic strip and screw insert.

### ADVANTAGES

When you need to put your phone down you can still have it in your hand with no effort.

When you want to take a steady picture, no need to worry about trying to hold the phone while still pressing the actual touch screen

Phone Ring is used for touch screen phones ???

### CAPABILITIES/FEATURES

Swivel feature that locks into vertical or horizontal position

Figure I is—Phone case that is durable and secure

Figure II or Figure III-Fashionable and secure double ring that can be worn with or without Figure I.

Easy to attach the two parts and ensure the security to hold your phone but at the same time easy to detach both pieces to use as you choose.

Figure's II and III will come in three different sizes for the single, double and triple ring; ideally your pointer finger and your middle finger. Small Medium and Large.

The fun part of switching out your rings (Figure's II and III) to connect and secure in with any of our cases (Figure I)

### SCENARIOS

Have you not wanted to take your phone with you while using the restroom or by the sink because you are afraid you might drop it in the water. With Phone Ring you can swivel and lock your phone securely to your hand using Figure I and Figure's II or III together

While you were talking and walking you trip and your phone flies out of your hand . . . Not with Phone Ring

After you have hung up with a call and you put your phone in your lap, you get up . . . your phone has fallen screen first on the ground (Shattered Screen) . . . Not when your locked tight to phone ring

You are watching a video on your phone, I-pad, or tablet, but your hand gets tired of holding it because you don't have a sturdy flat surface to use the kick stand or the case that props it up with Figure one secured to Figure's II or III and off the hand you can now stand your phone on that table or desk on its on.

That super important phone call you've been holding for, for the last 30 minutes and now you're home with a trunk full of groceries. Swivel the attached Figure Ito Figure III around your hand and safely hold your phone and stay on the line while taking the groceries in.

### BRIEF DESCRIPTION OF DRAWINGS

Figure I—View of phone case alone with inset for excepting ring insert

Figure II—View of fashionable ring for hand this piece will insert to Fig. I

Figure II-A—View of the back of Fig. II on hand showing insert mechanism

Figure III—View of ring design that will insert to Fig. I and has capability to swivel around finger(s) in a complete 360 degree motion

Figure IV—View of how Fig. I and Fig II or III will connect together while on the hand

Figure V—Side view of Fig. II about to insert to Fig. I inset mechanism.

1. Phone Ring is a phone accessory that uses an interlocking clasp mechanism, connecting a single, double or triple finger ring to a case that can be swiveled 360 degrees on the ring providing a “drop proof” protection grip to the phone preventing damage to the phone.
